(19) United States
(12) Patent Application Publication
(10) Pub. No.: US 2025/0070397 A1
(43) Pub. Date: Feb. 27, 2025

(54) BATTERY PACK AND BUS BAR

(71) Applicant: Prime Planet Energy & Solutions, Inc., Tokyo (JP)

(72) Inventor: Takashi INAMURA, Himeji-shi (JP)

(21) Appl. No.: 18/766,650

(22) Filed: Jul. 9, 2024

(30) Foreign Application Priority Data
Aug. 24, 2023 (JP) 2023-136267

(51) Int. Cl. H01M 50/503; H01M 50/209; H01M 50/507; H01M 50/516

(52) U.S. Cl. CPC H01M 50/503; H01M 50/209; H01M 50/507; H01M 50/516

(57) ABSTRACT

Each of a first battery cell and a second battery cell included in a battery pack includes an electrode terminal, a first bus bar includes a connection portion having a strip shape, the connection portion having both sides parallel to each other and each extending in an X axis direction, and the connection portion is provided with a through hole used for joining to the electrode terminal by welding, the through hole has a hexagonal shape formed by sequentially connecting a first corner portion, a second corner portion, a third corner portion, a fourth corner portion, a fifth corner portion, and a sixth corner portion, and an imaginary straight line connecting the first corner portion and the fourth corner portion is perpendicular to each of the both sides.

### CROSS REFERENCE TO RELATED APPLICATIONS

This nonprovisional application is based on Japanese Patent Application No. 2023-136267 filed on Aug. 24, 2023 with the Japan Patent Office, the entire contents of which are hereby incorporated by reference.

### BACKGROUND OF THE INVENTION

### Field of the Invention

The present technology relates to a battery pack and a bus bar.

### Description of the Background Art

Japanese Patent Laying-Open No. 2022-013957 discloses an invention of each of a bus bar and a battery module, and discloses a configuration in which a circular-shaped through hole is provided in the bus bar and a notch hole extending outward is provided in the through hole at a position displaced from the center of the through hole.

Japanese Patent Laying-Open No. 2021-163629 discloses an invention relating to a power supply device, a vehicle including the power supply device, and a power storage device, and discloses a configuration in which a through hole is provided at a central portion of an elliptical-shaped thin region of a bus bar.

Japanese Patent Laying-Open No. 2019-160727 discloses an invention relating to a power storage device, and discloses a configuration in which a circular-shaped through hole is provided in a bus bar and a notch hole extending outward from a central position of the through hole is provided in the through hole.

### SUMMARY OF THE INVENTION

Development of a cell-to-pack structure has been advanced in which a stack including a plurality of battery cells is directly accommodated in a case without using an end plate and a binding bar (module structure) each for restraining the plurality of battery cells.

In a structure in which a bus bar module, which is in the form of a module by accommodating a plurality of bus bars in a plate member, is mounted on a stack of a plurality of battery cells, each of the bus bars is used to connect adjacent battery cells in the stack including the plurality of battery cells.

For electric connection between a bus bar and a battery cell, welding is performed with an electrode of the battery cell being exposed from a through hole provided in the bus bar. After the welding, an image analysis is performed onto the welding portion so as to determine whether or not the welding has been appropriately performed.

The shape of the bus bar differs depending on a position at which the bus bar is used; however, when three sides of the bus bar are present around the through hole, based on respective edges (corner portions in the plate thickness) of the three sides, the position of the welding portion can be estimated and detected from positions of the three edges even if the shape of the through hole is distorted after the welding. As a result, whether or not the welding has been appropriately performed can be checked by the image analysis.

On the other hand, when only two sides, rather than the three sides, of the bus bar are present around the through hole, the position of the welding portion cannot be estimated and detected from positions of two edges. As a result, whether or not the welding has been appropriately performed cannot be checked by the image analysis.

It is an object of the present technology to provide a battery pack and a bus bar each having a configuration in which a welding location between the bus bar and a battery cell can be recognized by an image analysis regardless of a shape of the bus bar.

The present technology provides the following battery pack and bus bar.

[1]A battery pack comprising: a first stack including a plurality of first battery cells arranged side by side in a first direction; a second stack adjacent to the first stack in a second direction orthogonal to the first direction, the second stack including a plurality of second battery cells arranged side by side in the first direction; a case that has a side wall facing the first stack and the second stack in the first direction and that accommodates the first stack and the second stack; a first bus bar that electrically connects the plurality of first battery cells, and a first bus bar module that accommodates the first bus bar and that is disposed on the first stack; a second bus bar that electrically connects the plurality of second battery cells, and a second bus bar module that accommodates the second bus bar and that is disposed on the second stack; and a third bus bar that is provided to bridge between the first bus bar module and the second bus bar module along the second direction and that electrically connects one first battery cell selected from the first stack and one second battery cell selected from the second stack, wherein each of the first battery cells and the second battery cells includes an electrode terminal, each of the first bus bar, the second bus bar, and the third bus bar includes a plate portion having a strip shape, the plate portion having both sides parallel to each other and each extending in the second direction, the plate portion is provided with a through hole used for joining to the electrode terminal by welding, the through hole has a hexagonal shape formed by sequentially connecting a first corner portion, a second corner portion, a third corner portion, a fourth corner portion, a fifth corner portion, and a sixth corner portion, and an imaginary straight line connecting the first corner portion and the fourth corner portion is perpendicular to each of the both sides.

[2] The battery pack according to [1], wherein the hexagonal shape is a regular hexagonal shape.

[3] The battery pack according to [1] or [2], wherein the hexagonal shape is a shape line-symmetrical with respect to the imaginary straight line.

[4] The battery pack according to any one of [1] to [3], wherein the third bus bar includes a first region electrically connected to the first battery cell and located on the first bus bar module side, a second region electrically connected to the second battery cell and located on the second bus bar module side, and a third region provided at a position bridging between the first bus bar module and the second bus bar module, the third region communicating the first region and the second region, and the through hole is provided in each of the first region and the second region.

[5]A bus bar that electrically connects electrode terminals of adjacent battery cells of a plurality of battery cells arranged side by side, each of the plurality of battery cells including an electrode terminal, wherein the bus bar includes a plate portion having a strip shape, the plate portion having both sides parallel to each other and each extending in one direction, the plate portion is provided with a through hole used for joining to the electrode terminal by welding, and the through hole has a hexagonal shape formed by sequentially connecting a first corner portion, a second corner portion, a third corner portion, a fourth corner portion, a fifth corner portion, and a sixth corner portion, and an imaginary straight line connecting the first corner portion and the fourth corner portion is perpendicular to each of the both sides.

[6] The bus bar according to [5], wherein the hexagonal shape is a regular hexagonal shape.

[7] The bus bar according to [5] or [6], wherein the hexagonal shape is a shape line-symmetrical with respect to the imaginary straight line.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a battery pack according to an embodiment.

FIG. 2 is a perspective view of a battery cell according to the embodiment.

FIG. 3 is a top view of a plate member of a bus bar module according to the embodiment.

FIG. 4 is a perspective view showing a structure around a bus bar of the bus bar module according to the embodiment.

FIG. 5 is a perspective view of each of a first bus bar and a second bus bar according to the embodiment.

FIG. 6 is a plan view of each of the first bus bar and the second bus bar according to the embodiment.

FIG. 7 is a plan view of each of a first bus bar and a second bus bar according to another implementation of the embodiment.

FIG. 8 is a perspective view of a third bus bar according to the embodiment.

FIG. 9 is a plan view of the third bus bar according to the embodiment.

FIG. 10 is a partially enlarged plan view of the bus bars disposed in the bus bar module according to the embodiment.

FIG. 11 is a partially enlarged view of a third bus bar module in which a bus bar according to another implementation of the embodiment is employed.

FIG. 12 is a perspective view of the bus bar according to the other implementation of the embodiment.

FIG. 13 is a plan view of the bus bar according to the other implementation of the embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the “battery pack” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

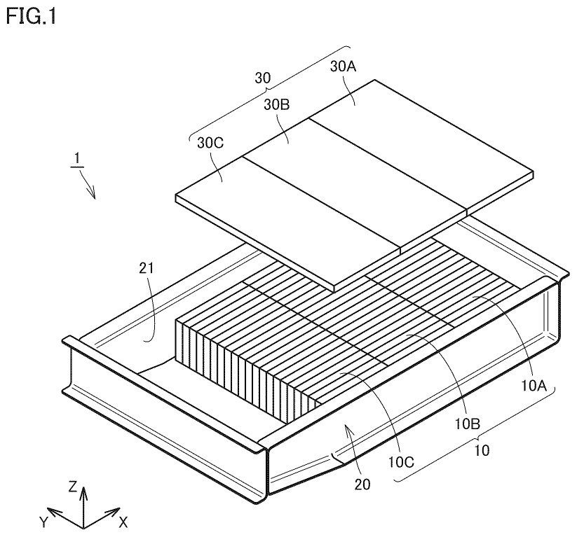

FIG. 1 is an exploded perspective view of a battery pack 1. As shown in FIG. 1, battery pack 1 includes: stacks 10 each including a plurality of battery cells 100 (see FIG. 2) arranged side by side in the Y axis direction (first direction); a case 20 that accommodates stacks 10; and bus bar modules 30 disposed on stacks 10.

Stacks 10 include a first stack 10A, a second stack 10B, and a third stack 10C. First stack 10A and second stack 10B are adjacent to each other in the X axis direction (second direction). Second stack 10B and third stack 10C are adjacent to each other in the X axis direction.

Case 20 has side walls 21 facing first stack 10A, second stack 10B, and third stack 10C in the Y axis direction. Side walls 21 directly support first stack 10A, second stack 10B, and third stack 10C from both sides in the Y axis direction. Thus, battery pack 1 according to the present embodiment employs a Cell-to-Pack structure in which stacks 10 each including the plurality of battery cells 100 are directly accommodated in the case.

Bus bar modules 30 include: a first bus bar module 30A disposed on first stack 10A; a second bus bar module 30B disposed on second stack 10B; and a third bus bar module 30C disposed on third stack 10C. In the present embodiment, first bus bar module 30A, second bus bar module 30B, and third bus bar module 30C have the same configuration, but may have different configurations.

FIG. 2 is a perspective view showing a configuration of each battery cell 100 included in first stack 10A, second stack 10B, and third stack 10C. As shown in FIG. 2, battery cell 100 has a prismatic shape. Battery cell 100 has electrode terminals 110, a housing 120, and a gas-discharge valve 130.

Electrode terminals 110 are formed on housing 120. Electrode terminals 110 have a positive electrode terminal 111 and a negative electrode terminal 112 as two electrode terminals 110 arranged side by side along the X axis direction (second direction) orthogonal to the Y axis direction (first direction). Positive electrode terminal 111 and negative electrode terminal 112 are provided to be separated from each other in the X axis direction.

Housing 120 has a substantially rectangular parallelepiped shape. An electrode assembly (not shown) and an electrolyte solution (not shown) are accommodated in housing 120. Housing 120 includes an upper surface 121, a lower surface 122, a first side surface 123, a second side surface 124, and a third side surface 125.

Upper surface 121 is a flat surface orthogonal to the Z axis direction. Electrode terminals 110 are disposed on upper surface 121. Lower surface 122 faces upper surface 121 along the Z axis direction (third direction) orthogonal to the Y axis direction (first direction) and the X axis direction (second direction).

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100 adjacent to each other in the Y direction face each other and second side surfaces 124 of battery cells 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When internal pressure of housing 120 becomes more than or equal to a predetermined value due to gas generated inside housing 120, gas-discharge valve 130 is opened to discharge the gas to the outside of housing 120.

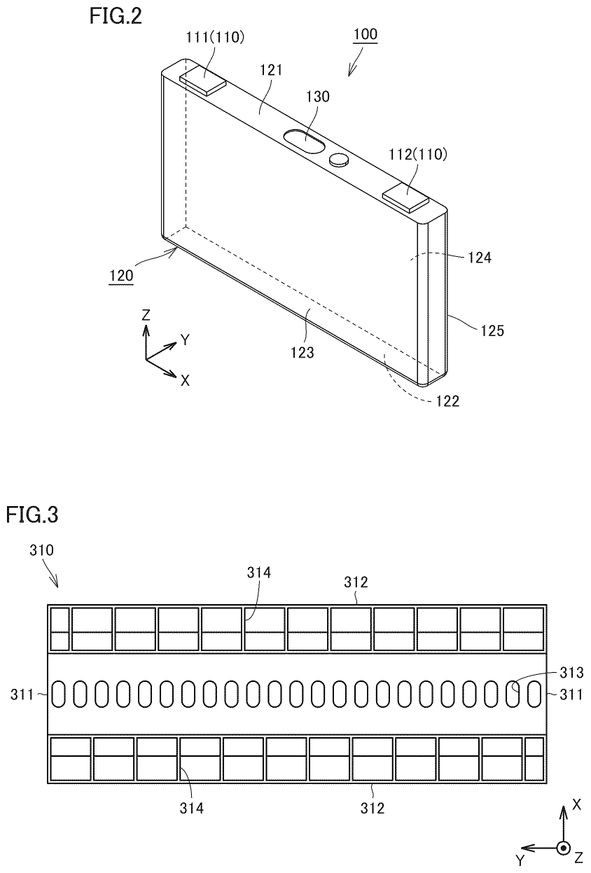

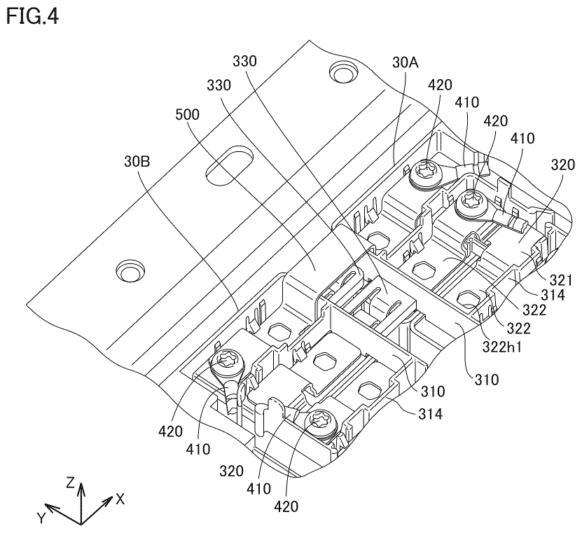

Next, a basic configuration of each bus bar module 30 will be described with reference to FIGS. 3 and 4. FIG. 3 is a top view of a plate member 310 included in bus bar module 30, and FIG. 4 is a perspective view showing a structure around the bus bar in the bus bar module.

Each of first bus bar module 30A, second bus bar module 30B, and third bus bar module 30C includes plate member 310 shown in FIG. 3. As shown in FIG. 3, plate member 310 includes: end surfaces 311 located at end portions in the Y axis direction; end surfaces 312 located at end portions in the X axis direction; through holes 313 formed at positions corresponding to gas-discharge valves 130 of battery cells 100; and wall portions 314 that partition a space on plate member 310 into a plurality of spaces.

As shown in FIG. 4, in first bus bar module 30A, a bus bar 320 (first bus bar) is accommodated in each space partitioned by wall portion 314. Bus bar 320 (first bus bar) is composed of a conductor (typically, a metal member). Bus bar 320 (first bus bar) electrically connects electrode terminals 110 of the plurality of battery cells 100 to each other. Bus bar 320 (first bus bar) includes a root portion 321 extending in the Y axis direction and a pair of connection portions 322 (first and second connection portions) each protruding from root portion 321 in the X axis direction. Connection portions 322 are each connected to electrode terminals 110 of two adjacent battery cells 100 in the Y axis direction.

Bus bar 320 is connected to a wiring 410. Wiring 410 is fixed to bus bar 320 (first bus bar) by a screw 420. The implementations of wiring 410 and screw 420 are not limited to those shown in FIG. 4, and the wiring may be constituted of, for example, a flexible wiring board.

Electrode terminal 110 of battery cell 100 and bus bar 320 (first bus bar) are positioned relative to each other in the X axis direction and the Y axis direction and are then joined to each other by welding. By precisely performing this positioning, the step of welding electrode terminal 110 and bus bar 320 (first bus bar) can be performed in a highly efficient and high-quality manner. A through hole 322h1 provided in bus bar 320 is used for the joining by welding.

As shown in FIG. 4, also in second bus bar module 30B, as with first bus bar module 30A, a bus bar 320 (second bus bar) is accommodated in each space partitioned by wall portion 314. The configuration and function of bus bar 320 (second bus bar) are the same as those of bus bar 320 (first bus bar).

As shown in FIG. 4, a bus bar 500 (third bus bar) is provided along the X axis direction so as to bridge between first bus bar module 30A and second bus bar module 30B and electrically connects one battery cell 100 (first battery cell) selected from first stack 10A and one battery cell 100 (second battery cell) selected from second stack 10B. Likewise, although not shown, a bus bar 500 is provided between second bus bar module 30B and third bus bar module 30C.

Bus bar 500 is connected to a wiring 410. Wiring 410 is fixed to bus bar 500 by a screw 420. The implementations of wiring 410 and screw 420 are not limited to those shown in FIG. 4, and the wiring may be constituted of, for example, a flexible wiring board.

In the present embodiment, one battery cell 100 (first battery cell) selected from first stack 10A is a battery cell located at an endmost position (at a very end in the Y axis direction) facing side wall 21, whereas one battery cell 100 (second battery cell) selected from second stack 10B is a battery cell located on the same side as one battery cell 100 (first battery cell) selected from first stack 10A (located adjacent thereto in the X axis direction and located at the very end in the Y axis direction). It should be noted that the position at which bus bar 500 is provided is not limited to the position shown in the figure.

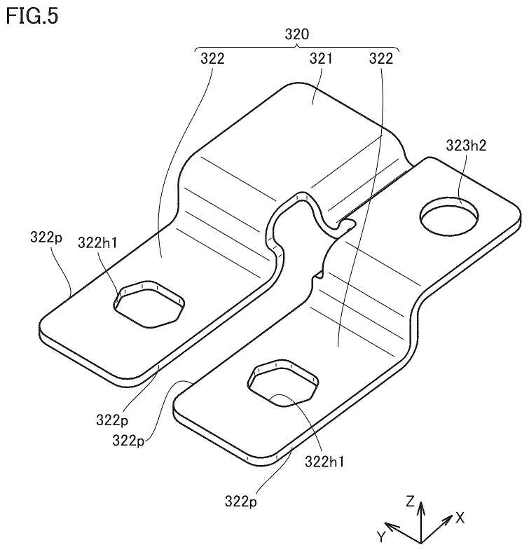

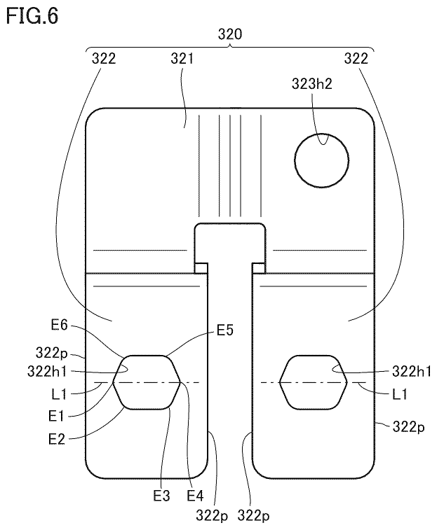

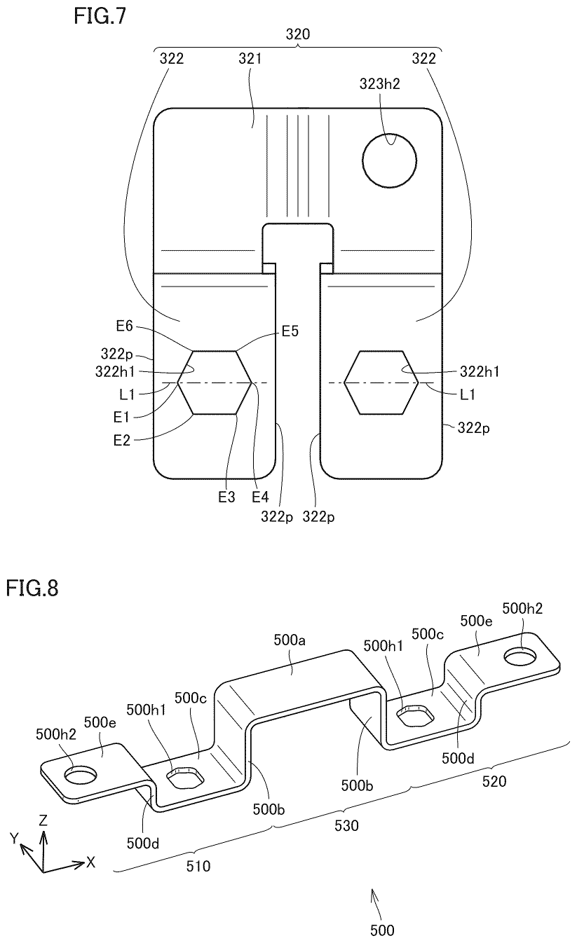

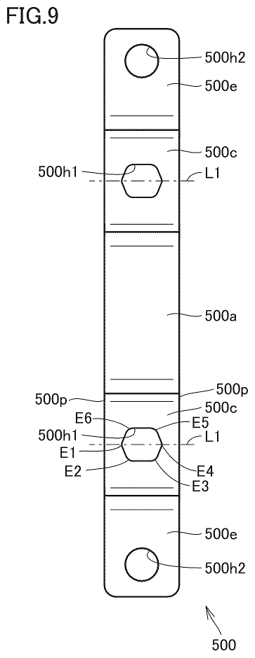

Next, a specific configuration of each of the bus bars will be described with reference to FIGS. 5 to 8. FIG. 5 is a perspective view of each bus bar 320 (first and second bus bars), FIG. 6 is a plan view of bus bar 320, FIG. 7 is a plan view of a bus bar 320 according to another implementation, FIG. 8 is a perspective view of bus bar 500 (third bus bar), and FIG. 9 is a plan view of bus bar 500.

A specific shape of bus bar 320 will be described with reference to FIGS. 5 and 6. Bus bar 320 is composed of a conductor (typically, a metal member) as described above. Bus bar 320 electrically connects electrode terminals 110 of the plurality of battery cells 100 to each other. Bus bar 320 has a substantially U shape when viewed in a plan view, and includes: a root portion 321 extending in the Y axis direction; and a first connection portion 322 and a second connection portion 323 (first and second connection portions) each protruding from root portion 321 in the X axis direction. Connection portions 322 are each connected to electrode terminals 110 of two adjacent battery cells 100 in the Y axis direction.

A through hole 323h2 is provided on the second connection portion 323 side of root portion 321. Root portion 321 and each connection portion 322 are provided so as to have different heights in the Z axis direction. In FIG. 5, root portion 321 is provided to be higher than connection portion 322.

Each of connection portions 322 is constituted of a plate portion having a strip shape, the plate portion having both sides 322p parallel to each other and each extending in the X axis direction. Through hole 322h1 provided in connection portion 322 is used for joining to electrode terminal 110 by welding. As shown in FIG. 6, through hole 322h1 has a hexagonal shape formed by sequentially connecting a first corner portion E1, a second corner portion E2, a third corner portion E3, a fourth corner portion E4, a fifth corner portion E5, and a sixth corner portion E6. Further, an imaginary straight line L1 connecting first corner portion E1 and fourth corner portion E4 is perpendicular to each of both sides 322p.

Here, each of the corner portions is not necessarily an acute corner portion, and may be a corner portion having roundness to some extent. In the present embodiment, the hexagonal shape is a shape line-symmetrical with respect to imaginary straight line L1; however, for example, as shown in FIG. 7, the shape of through hole 322h1 may be a regular hexagonal shape in which the lengths of the sides between the corner portions are the same.

It should be noted that a distance between first corner portion E1 and fourth corner portion E4 is preferably large due to the following reason: even if the shape of through hole 322h1 becomes distorted because of the connection to electrode terminal 110 of battery cell 100 by the welding, first corner portion E1 and fourth corner portion E4 need to remain due to a below-described reason.

Next, a specific shape of bus bar 500 will be described with reference to FIGS. 8 and 9. As with bus bar 320, bus bar 500 is composed of a conductor (typically, a metal member). As described above, bus bar 500 is provided to bridge between first bus bar module 30A and second bus bar module 30B, and electrically connects one battery cell 100 (first battery cell) selected from first stack 10A and one battery cell 100 (second battery cell) selected from second stack 10B.

Bus bar 500 includes: a first region 510 electrically connected to battery cell 100 (first battery cell) and located on the first bus bar module 30A side; a second region 520 electrically connected to battery cell 100 (second battery cell) and located on the second bus bar module 30B side; and a third region 530 provided at a position bridging between first bus bar module 30A and second bus bar module 30B, third region 530 communicating first region 510 and second region 520.

Further, when bus bar 500 is viewed along the Z axis direction (third direction) orthogonal to the Y axis direction (first direction) and the X axis direction (second direction), third region 530 has a protruding shape so as to be located above first region 510 and second region 520.

Specifically, third region 530 includes: a top surface portion 500a; and a pair of first side wall portions 500b located beside both sides of top surface portion 500a in the X axis direction and extending downward.

First region 510 has: a bottom surface portion 500c; a second side wall portion 500d extending upward from one end of bottom surface portion 500c; and an extension portion 500e extending parallel to bottom surface portion 500c from the upper end of second side wall portion 500d. Bottom surface portion 500c is provided with a through hole 500h1 having a hexagonal shape, and extension portion 500e is provided with a through hole 500h2 having a circular shape.

As with first region 510, second region 520 has: a bottom surface portion 500c; a second side wall portion 500d extending upward from one end of bottom surface portion 500c; and an extension portion 500e extending parallel to bottom surface portion 500c from the upper end of second side wall portion 500d. Bottom surface portion 500c is provided with a through hole 500h1 having a hexagonal shape, and extension portion 500e is provided with a through hole 500h2 having a circular shape.

Each through hole 500h1 is used to join electrode terminal 110 of battery cell 100 and bottom surface portion 500c by welding. Each through hole 500h2 is used to fasten wiring 410 using screw 420.

Bus bar 500 in the present embodiment is provided with each extension portion 500e at a height position between bottom surface portion 500c and top surface portion 500a when viewed along the Z axis direction (third direction).

First region 510, second region 520, and third region 530 are integrally formed, and are constituted of a plate portion having a strip shape, the plate portion having both sides 500p parallel to each other and each extending in the X axis direction. Through hole 500h1 provided in bottom surface portion 500c is used for joining to electrode terminal 110 by welding. As shown in FIG. 9, through hole 500h1 has a hexagonal shape formed by sequentially connecting a first corner portion E1, a second corner portion E2, a third corner portion E3, a fourth corner portion E4, a fifth corner portion E5, and a sixth corner portion E6. Further, an imaginary straight line L1 connecting first corner portion E1 and fourth corner portion E4 is perpendicular to each of both sides 500p.

Here, each of the corner portions is not necessarily an acute corner portion, and may be a corner portion having roundness to some extent. In the present embodiment, the hexagonal shape is a shape line-symmetrical with respect to imaginary straight line L1; however, for example, the shape of through hole 500h1 may be a regular hexagonal shape in which the lengths of the sides between the corner portions are the same.

It should be noted that a distance between first corner portion E1 and fourth corner portion E4 is preferably large due to the following reason: even if the shape of through hole 500h1 becomes distorted because of the connection to electrode terminal 110 of battery cell 100 by welding, first corner portion E1 and fourth corner portion E4 need to remain for a below-described reason.

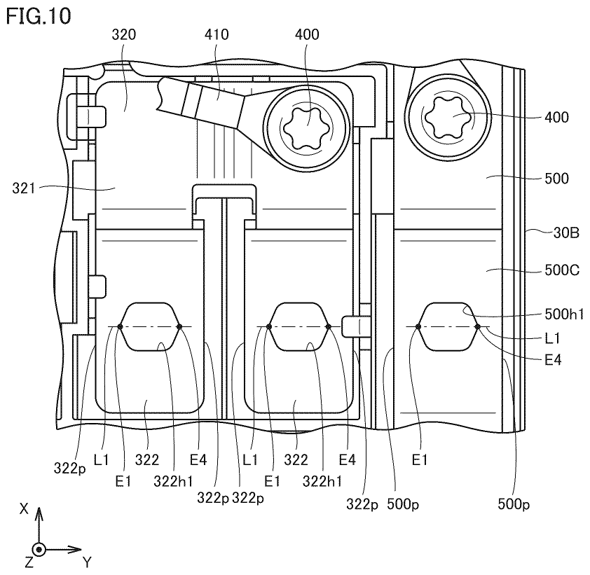

Next, functions and effects of through hole 322h1 provided in bus bar 320 and through hole 500h1 provided in bus bar 500 will be described with reference to FIG. 10. FIG. 10 is a partially enlarged plan view of bus bar 320 and bus bar 500 disposed in second bus bar module 30B.

Through hole 322h1 and through hole 500h1 are arranged side by side in the Y axis direction. Although not shown, electrode terminal 110 of battery cell 100 and connection portion 322 are electrically connected to each other by welding using through hole 322h1. Likewise, electrode terminal 110 of battery cell 100 and bottom surface portion 500c are electrically connected by welding using through hole 500h1. After the welding, each of the shapes of through hole 322h1 and through hole 500h1 becomes distorted, with the result that the hexagonal shape thereof cannot be often recognized.

Here, the welding is performed to avoid each of first corner portion E1 and fourth corner portion E4 of the hexagonal shape of the hole from being collapsed by the welding. In this way, imaginary straight line L1, by which first corner portion E1 and fourth corner portion E4 can be recognized by image recognition after the welding, can be obtained. As a result, in the case of bus bar 320, the position of the welding location can be estimated from the positions of both sides 322p disposed in parallel and the position of imaginary straight line L1, with the result that the image recognition of the welding location can be attained. Likewise, in the case of bus bar 500, the position of the welding location can be estimated from the positions of both sides 500p disposed in parallel and the position of imaginary straight line L1, with the result that the image recognition of the welding location can be attained.

As described above, according to the bus bar of the present embodiment, the welding location between the bus bar and the battery cell can be recognized by the image analysis regardless of the shape of the bus bar. Further, since the through hole used for the welding location has the hexagonal shape as described above, it is possible to improve efficiency of a checking operation using the image processing technology even when there are many locations at each of which a welding state is checked using the image recognition.

### (Bus Bar According to Another Implementation)

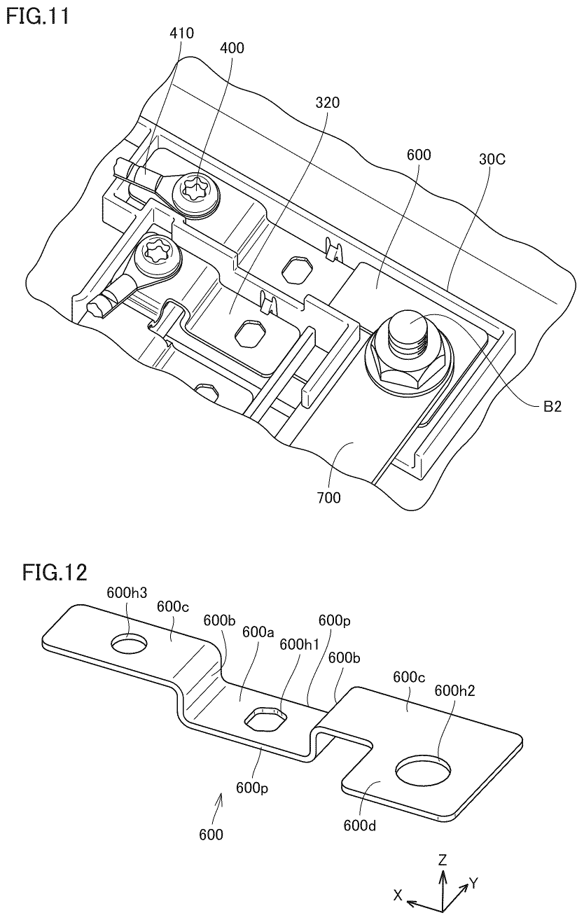

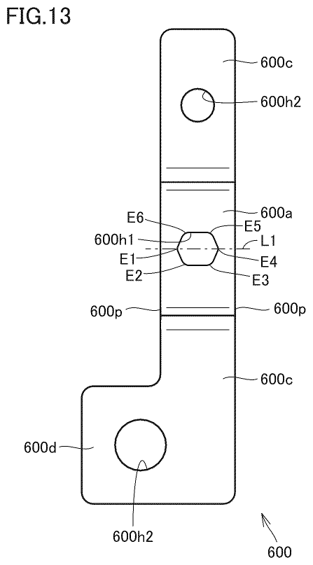

Referring to FIGS. 12 and 13, a bus bar 600 according to another implementation, which is provided with a through hole having a hexagonal shape and used for welding, will be described. FIG. 11 is a partially enlarged view of a third bus bar module 30C in which bus bar 600 according to the other implementation is employed, FIG. 12 is a perspective view of bus bar 600 according to the other implementation, and FIG. 13 is a plan view of bus bar 600 according to the other implementation.

For example, bus bar 600 has one end to which a wiring 410 is connected by a screw 420, and has the other end to which a plate terminal 700 external thereto is fastened by a bolt B2. Bus bar 600 has a recessed shape in the Z axis direction, and has: a bottom surface portion 600a; a pair of side wall portions 600b extending upward from respective sides of bottom surface portion 600a; and a pair of extension portions 600c extending in the X axis direction from the respective upper ends of the pair of side wall portions 600b. One of extension portions 600c is provided with an enlarged portion 600d extending in the Y axis direction.

Bottom surface portion 600a is provided with a through hole 600h1 having a hexagonal shape, and extension portion 600c is provided with a through hole 600h2 having a circular shape.

Through hole 600h1 is used to join electrode terminal 110 of battery cell 100 and bottom surface portion 600a by welding. Through hole 600h2 is used to fasten wiring 410 using screw 420 or to fasten plate terminal 700 using bolt B2.

Bus bar 600 is integrally formed and is constituted of a plate portion having a strip shape, the plate portion having both sides 600p parallel to each other and each extending in the X axis direction. Through hole 600h1 provided in bottom surface portion 600a is used for joining to electrode terminal 110 by welding. As shown in FIG. 13, through hole 600h1 has a hexagonal shape formed by sequentially connecting a first corner portion E1, a second corner portion E2, a third corner portion E3, a fourth corner portion E4, a fifth corner portion E5, and a sixth corner portion E6. Further, an imaginary straight line L1 connecting first corner portion E1 and fourth corner portion E4 is perpendicular to each of both sides 600p.

Here, each of the corner portions is not necessarily an acute corner portion, and may be a corner portion having roundness to some extent. In the present embodiment, the hexagonal shape is a shape line-symmetrical with respect to imaginary straight line L1; however, for example, as with the bus bar shown in FIG. 7, the shape of through hole 600h1 may be a regular hexagonal shape in which the lengths of the sides between the corner portions are the same.

Also in bus bar 600 having this configuration, the same functions and effects as those of bus bar 320 and bus bar 500 described above can be obtained.

It should be noted that the configuration of the bus bar provided with the through hole that has the hexagonal shape and that is used for the welding is merely an example, and it is not limited to the configuration of the bus bar, and the through hole having the hexagonal shape and used for the welding can be applied to various configurations of the bus bar.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a first stack including a plurality of first battery cells arranged side by side in a first direction;
a second stack adjacent to the first stack in a second direction orthogonal to the first direction, the second stack including a plurality of second battery cells arranged side by side in the first direction;
a case that has a side wall facing the first stack and the second stack in the first direction and that accommodates the first stack and the second stack;
a first bus bar that electrically connects the plurality of first battery cells, and a first bus bar module that accommodates the first bus bar and that is disposed on the first stack;
a second bus bar that electrically connects the plurality of second battery cells, and a second bus bar module that accommodates the second bus bar and that is disposed on the second stack; and
a third bus bar that is provided to bridge between the first bus bar module and the second bus bar module along the second direction and that electrically connects one first battery cell selected from the first stack and one second battery cell selected from the second stack, wherein
each of the first battery cells and the second battery cells includes an electrode terminal,
each of the first bus bar, the second bus bar, and the third bus bar includes a plate portion having a strip shape, the plate portion having both sides parallel to each other and each extending in the second direction,
the plate portion is provided with a through hole used for joining to the electrode terminal by welding,
the through hole has a hexagonal shape formed by sequentially connecting a first corner portion, a second corner portion, a third corner portion, a fourth corner portion, a fifth corner portion, and a sixth corner portion, and an imaginary straight line connecting the first corner portion and the fourth corner portion is perpendicular to each of the both sides.

2. The battery pack according to claim 1, wherein the hexagonal shape is a regular hexagonal shape.

3. The battery pack according to claim 1, wherein the hexagonal shape is a shape line-symmetrical with respect to the imaginary straight line.

4. The battery pack according to claim 1, wherein
the third bus bar includes
a first region electrically connected to the first battery cell and located on the first bus bar module side,
a second region electrically connected to the second battery cell and located on the second bus bar module side, and
a third region provided at a position bridging between the first bus bar module and the second bus bar module, the third region communicating the first region and the second region, and
the through hole is provided in each of the first region and the second region.

5. A bus bar that electrically connects electrode terminals of adjacent battery cells of a plurality of battery cells arranged side by side, each of the plurality of battery cells including an electrode terminal, wherein
the bus bar includes a plate portion having a strip shape, the plate portion having both sides parallel to each other and each extending in one direction,
the plate portion is provided with a through hole used for joining to the electrode terminal by welding, and
the through hole has a hexagonal shape formed by sequentially connecting a first corner portion, a second corner portion, a third corner portion, a fourth corner portion, a fifth corner portion, and a sixth corner portion, and an imaginary straight line connecting the first corner portion and the fourth corner portion is perpendicular to each of the both sides.

6. The bus bar according to claim 5, wherein the hexagonal shape is a regular hexagonal shape.

7. The bus bar according to claim 5, wherein the hexagonal shape is a shape line-symmetrical with respect to the imaginary straight line.
